(19) United States
(12) Patent Application Publication
(10) Pub. No.: US 2005/0228848 A1
(43) Pub. Date: Oct. 13, 2005

(54) Method and system for operating a peer network

(76) Inventors: Stacy D. Thurston, Foster City, CA (US); Michael S. Lemley, Mountain View, CA (US)

Correspondence Address: Michael S. Lemley, 733 Caravel Lane, Foster City, CA, 94404, US

(21) Appl. No.: 10/806,304

(22) Filed: Mar. 22, 2004

Related U.S. Application Data
(60) Provisional application No. 60/515,060.

(51) Int. Cl. G06F 15/16

(52) U.S. Cl. 709/200

(57) ABSTRACT

A method for operating a peer network on a computer network is presented. A Peer may be registered by name (Peername) into a Peername System (PNS). The Peer runs software that communicates with a Gateway computer located on the computer network. Users on the computer network connect to the PNS, for example, by surfing to the PNS with browser software. The user submits a request to the PNS to be routed to the Peer associated with a particular Peername. The PNS routes the user to the appropriate Gateway computer with which the Peer communicates. The Gateway passes the user's request to the Peer, and passes the Peer's response back to the user.

This application claims priority of filing based on Provisional Patent Application 60/515060 entitled “System and Method for Operating a Peer Site Network.”

### FIELD OF THE INVENTION

The present invention relates to computer networking and applications, and more particularly to a method and system for registering Peernames and administering a name-based peer network, including operation of the network over the Internet.

### BACKGROUND INFORMATION

As is known in the art, a computer can be accessible on the Internet by locating the computer according to the computer's Internet Protocol address, or IP address. Additionally, computers may be accessible on the Internet as the result of registration in the Domain Name System (DNS). DNS servers will accept a domain name or URL of a computer on the Internet and resolve the IP address of the computer for the user making the request. Thus, a user provides a domain name to the DNS server, and the DNS server provides the user with the IP Address of the computer associated with the registered domain name.

The Internet provides a vast array of computer resources to individuals equipped with a connection to the Internet and a browser to access and display content available from web sites on the Internet. An Internet connection is typically provided through an Internet service provider (“ISP”), and users can then access computers that have been registered on DNS. In addition, there have been a number of peer-to-peer (“P2P”) structures established on the Internet, such as Napster, Kazaa, and Gnutella, which allow users to transfer files to their own computers from anonymous computers that have connected to the P2P network. Typically, the user must be connected to the P2P network through proprietary peer client software.

In addition, there are other technologies and various methods by which users may transfer content over the Internet from computer to computer. For example, users may send e-mail with attachments, use streaming media technology for certain types of media downloads, use the File Transport Protocol or FTP. However, all of these methods fail to provide certain features that the present invention provides. For example, the present invention allows a computer to provide content to any number of users at any given time, without registering the computer in the Domain Name System (“DNS”) and running a web server application on a computer that is hosted by an Internet hosting service.

There are other shortcomings of the existing technologies as well. For example, E-mail often proves inadequate as a method for transporting files due to size limitation or restrictions that Internet Service Providers (ISPs) often place upon e-mail systems. E-mail servers have limitations and may become overburdened by excessive correspondence and attachments passing through the servers.

Although peer networks are effective, existing peer technologies typically do not provide a manner to connect to a specific peer on the network. Rather, existing peer networks typically are content driven, meaning that, rather than seek a destination, users seek certain files or content and have no control over which peer computer such content originated. Additionally, existing peer networks often have negligible security features.

According to an embodiment of the present invention, a user may locate a computer that is connected to the Internet where the computer does not have a registered domain name through DNS. In addition, the user does not have to know the computer's IP address.

The present invention will allow entities to decentralize the distribution of content, which provides for more efficient and less expensive methods of distribution. For an entity to provide content from a centralized location causes the bandwidth requirement for such location to increase and therefore increases the cost to maintain the location.

The present technology provides for decentralization of content and efficient distribution of resources and content over the Internet. Principally, the peer network allows any of the computers on it to act as both browsers of content and servers of content. Additionally, existing applications, such as instant messaging, email, content serving, etc., may take advantage of the network connections that the peer devices make to enhance communications across the Internet.

### BRIEF DESCRIPTION OF THE DRAWINGS

FIG. 1 shows a schematic of a browser that has access to a Peername Server, Peer Gateway, and Peersites Program according to an embodiment of the present invention.

FIG. 2 shows a browser accessing the Peername Service in order to locate a Peersites Program on a computer network according to one embodiment of the present invention.

FIG. 3 shows a representation of web browsers accessing Peersites Programs behind a firewall.

FIG. 4 shows a computer to computer communication to represent how various applications and web services can be shared over the Peersites Network.

FIGS. 5 and 6 show embodiments of the present invention configured for secure mail and secure browsing, respectively, between peer locations.

FIG. 7 shows a schematic diagram of the Peername Registration System.

FIG. 8 shows another embodiment of the Peersites Network of the present invention.

FIG. 9 shows one embodiment of the Peername Service depicting an exemplary system hierarchy.

FIG. 10 shows a flow diagram of a communication section between Peers on the Peersites Network according to an embodiment of the present invention.

FIG. 11 shows a schematic diagram of communication links according to one embodiment of the present invention.

FIG. 12 shows a schematic diagram of communication links according to another embodiment of the present invention.

FIG. 13 shows a schematic diagram of communication links according to an alternative embodiment of the present invention.

FIG. 14 shows a flow diagram of a peer-to-peer communication process according to the present invention.

### DETAILED DESCRIPTION OF THE INVENTION

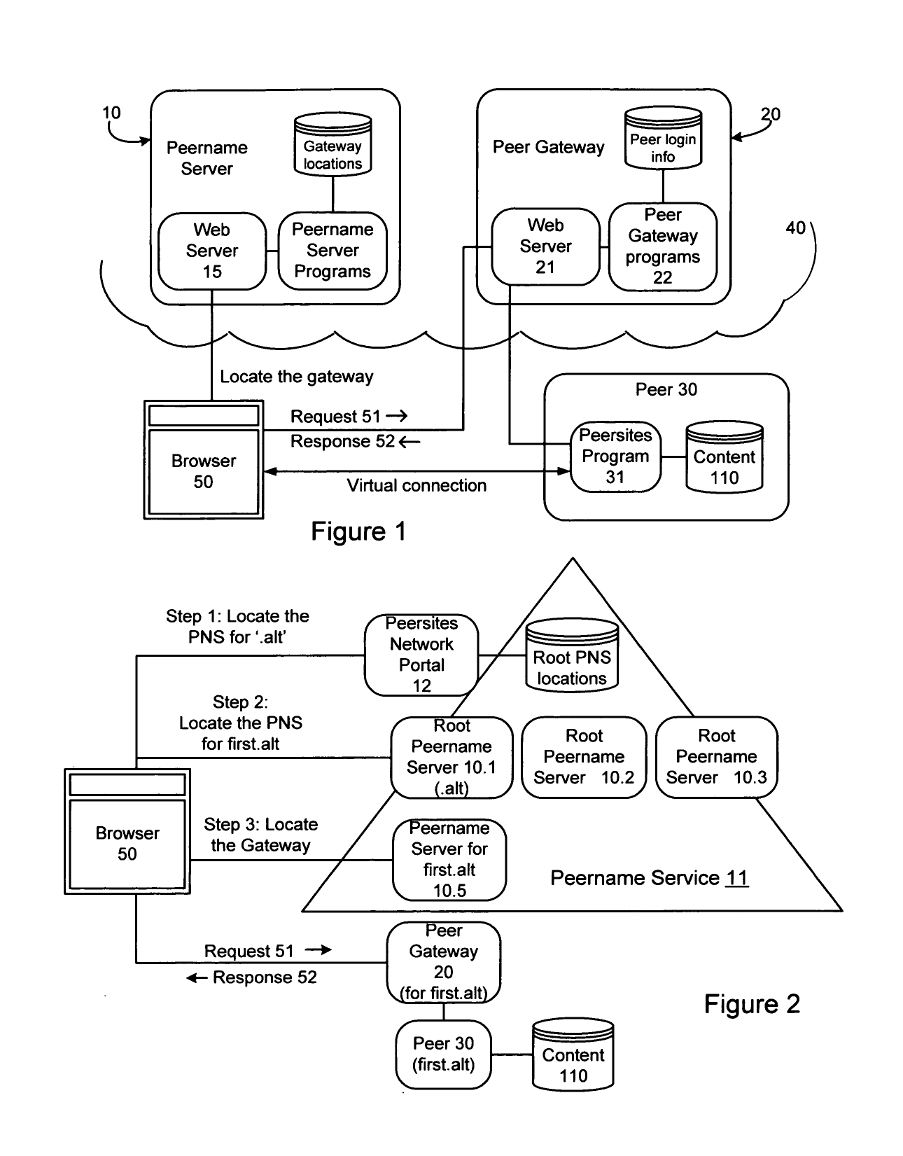

As shown in FIG. 1, an embodiment of the present invention includes a Peername Server 10, a Peer Gateway 20, and a Peer 30. The Peername Server 10 and Peer Gateway 20 are located on a computer network 40 that is accessible by both a user 50 (represented in this case by a browser) and by the Peer 30. The Peer 30 does not need to be located on a computer network that is accessible by the user 50, provided that both the user 50 and the Peer 30 have access to computer network 40 on which the Peername Server 10 and Peer Gateway 20 are located. In this way, for example, a user 50 on a private intranet can access a Peer 30 on a second private intranet, as long as the two private intranets allow a connection to a common computer network 40. According to one embodiment of the invention, the computer network 40 is the Internet. Thus, for example, the Peername Server 10 and Peer Gateway 20 may have static IP addresses, or a URL that can be resolved through use of the Domain Name Service (DNS) on the Internet, as is known in the art. The common computer network 40 could also be a private network.

The Peername Server 10 and Peer Gateway 20 provide routing and communication via the computer network 40 between Peers 30 and users 50. A user 50 is an individual who may access a Peer 30 through use of standard browser software (such as Netscape, Internet Explorer, or Mozilla web browsers). The user 50 accesses the Peer 30 by following the steps of communicating with the Peername Server 10 to obtain the location or IP Address of the Peer Gateway 20 associated with the Peer 30, then by communicating with the Peer Gateway 20, in order to establish communication with the Peer 30.

The Peer 30 has a unique name identifier referred to as a Peername. The user 50 provides the Peername Server 10 with the unique Peername of the Peer 30 with which the user 50 would like to communicate. The Peername Server 10, which may, for example use Web Server 15 functions to communicate with the user 50 as is known in the art, accepts the Peername and processes the Peername in order to determine the Peer Gateway 20 through which the Peer 30 can communicate. The user 50 is then routed to and communicates with the Peer Gateway 20. The Peer Gateway 20 may use Web Server 21 functions to communicate with the user 50, as is known in the art. Alternatively, the Peername Server 10, and the Peer Gateway 20 may communicate with the user by any other suitable communication functionality, such as using code that implements HTTP, TCP/IP and/or UDP protocols as are known in the art. The Peer Gateway 20 processes the Peername request from the user 50 by executing Peer Gateway programs 22 to determine whether the Peer 30 associated with the Peername is logged into the Peer Gateway 20. Peer 30 must initiate contact with the Peer Gateway 20 in order to establish the communication link between the Peer Gateway 20 and Peer 30. This may be done, for example, with HTTP, TCP/IP, or other known communications protocols as are known in the art. If the Peer 30 is logged in or has otherwise created a communication link with Peer Gateway 20, then Peer Gateway 20 can establish a communication link between the user 50 and the Peer 30, and will pass requests 51 and responses 52 between the them. According to one embodiment of the present invention, the Peer Gateway 20 remains in the communication path between the user 50 and the Peer 30, thus the communication link between the user 50 and the Peer 30 is referred to as a virtual connection. According to a further embodiment of the invention, the Peer Gateway 20 provides communication information to the user 50 and/or the Peers 30 in order for the user 50 and the Peer 30 computers to link directly to each other without going through the Peer Gateway 20, in which case there would be an actual connection. To have an actual connection, either computer hosting the browser 50, or the computer hosting Peer 30 must be on a network accessible to the other computer, and without a firewall blocking that connection. Otherwise, the communication link must be made using the Gateway 20, that acts as an intermediary between the two computers that would otherwise not be able to form a communication link between them.

Generally, the Peer 30 will not have a DNS entry in the Domain Name System. That is, the Peer 30 will not typically be a Web Site on the Internet (though it would not be prohibited for the computer running the Peersites Program 31 to also run a Web Site program accessible via a DNS domain name lookup). According to the present invention, each Peer 30 includes a Peersites Program 31, which provides the functionality that enables the Peer 30 to communicate with the Peer Gateway 20 and which provides the communication with the computer upon which the Peersites Program 31 is running. The Peersites Program 31 may use communications protocols as are known in the art to communicate with the Peer Gateway 20, such as HTTP, TCP/IP, or UDP. The Peersites Program 31 communicates with the Peer Gateway 20 through a login procedure. In this way, the Peer 30 communicates to the Peer Gateway 20 that the Peer 30 is online and in a state of readiness. For example, the Peer 30 is ready to receive a request from a user 50 (generically, a UserRequest 51). A UserRequest 51 can be any type of request from a user 50, which includes, for example, requests for content, request for application services, or any other program or service that is available from the Peersites Program 31 (collectively content 110). The Peersites Program 31 has the functionality to respond to different types of UserRequests 51. For example, placing server functionality into the Peersites Program 31 allows the computer upon which the Peersites Program 31 is running to serve content in response to UserRequests 51. Placing VNC software (Virtual Network Computing) as is known in the art, allows a Peersites Program 31 to remotely run desktop applications over the Peersites Network. It is contemplated that third parties will develop additional applications or services that will interoperate with the Peersites Program 31 in order to allow processing of numerous types of UserRequests 51.

FIG. 2 shows a detail of the Peername Service 11. The Peername Service 11 provides the function of storing a database of Peernames and associating a Peername with at least one Peer Gateway 20. The Peername Service 11 may employ a number of Peername Servers 10 (10.1, 10.2, 10.3) that, for example contain a hierarchical naming structure whereby any Peername may be placed appropriately into the hierarchical structure for later location. For example, the set of all Peernames may include Peernames that have extensions of .alt (10.1), .home (10.2), .work (10.3) and etc. Any type of naming convention may be used, and the convention of using extensions is exemplary only. The Peername Service 11 will have a Root Peername Server 10 that, for example, tracks the location of other Peername Servers 10.1, 10.2 etc. that have Peername information for a specific level of the hierarchy of Peernames, such as the alt, peer or some other subset. The Peername Service 11 may use as many or as few Peername Servers 10 as necessary to organize the Peernames. Ultimately, the Peername will be traced through the Peername Servers 10 until the Peername is associated with a Peer Gateway 20. For example, as shown in the FIG. 2, a user 50 makes a request 51 for the Peername ‘first.alt’ via a portal 12 that sends the request to the Peername Service 11. The Peername Service 11 parses the Peername to determine that it is associated with the alt Peername Server 10.1, which can determine further subdivisions to find the Peername Server. 0.5 for the Peername first.alt. Peername Server 10.5 thus finally associates the Peername first.alt with an appropriate Peer Gateway 20 through which the first.alt Peersites Program 31 will communicate with users 50 or other Peersites Programs 31. The Peername Service 11, Peer Gateways 20, and Peers 30 are referred to collectively as the Peersites Network.

It should be noted that a user 50 that wishes to locate a Peer 30 may do so by connecting to the Peername Service 11 directly or through any other computer on the computer network 40 that can route a request to the Peername Service 11. Further, the Peername Service 11 may be located on the Internet and have a DNS entry, in the case of a publicly available Peersites Network, or may be located, for example, behind a firewall in a company's privately hosted network for maintenance of a private Peersites Network. In the latter case, the Peername Service 11 has restricted access of a limited computer network, such as a Local Area Network (LAN), or a private network. In the event that the Peersites Network is on the Internet, the Peername Service 11 will have a URL that can be used by Internet users 50 to find the Peername Service 11. The Peername Service 11 provides information to a user 50 to enable the user 50 to locate the Peer Gateway 20 to which the user 50 will connect in order to communicate a UserRequest 51 to the Peer 30. The Peer Gateway 20 may be nested through various Gateway levels, for example, a high level Peer Gateway 20 may route a user to a second, intermediate Peer Gateway 20, in order to reach a third Peer Gateway 20 with which the Peersites Program 31 communicates. The UserRequest 51 reaches the Peer Gateway 20 to which the Peersites Program 31 is configured to communicate. The Peer Gateway 20 determines whether the Peersites Program 30 is currently logged-in to accept a UserRequest 51 from the Peer Gateway 20, and, if so, the Peer Gateway 20 passes the UserRequest 51 to the Peersites Program 31.

The Peersites Program 31 provides a response 52 to the Peer Gateway 20, which the Peer Gateway 20 passes back to the user 50. The response 52 may be any form that is appropriate to the kinds of services or applications running on the Peersites Program 31. For example, if the Peersites Program 31 is configured to serve content, then the response may be an html page, or a directory of pictures or other files, whereas, if the Peersites Program 31 is configured to run a desktop control application (such as VNC), then the response 52 will be related to the running of the desktop control application on the Peersites Program 31. The Peersites Program 31 may be configured to run a virtually unlimited number of web applications, that is, software programs that may be run over a network by a computer program that has web server functionality. The web server functionality may be of a type commonly known in the industry, or may be developed in the future. The web application may need to be configured or modified to interface with the Peersites Program 31 in an appropriate manor in order for the web application to execute properly and run over the Peersites Network. For example, the Peersites Program 31 may include an Application Programming Interface (API) that provides a means for external programs, such as web applications or other software programs, to communicate with the Peersites Program 31. The approach of using an API to facilitate communication or integration of software programs is known in the art.

According to one embodiment of the present invention, the Peer Gateway 20 establishes a virtual connection between the Peersites Program 31 and the user 50, such that traffic between them flows through the Peer Gateway 20. A preferred embodiment provides that the Peer Gateway 20 begins to pass packets of information that make up the response 52 as soon as the packets are received by the Peer Gateway 20. The entire response 52 is not received by the Peer Gateway 20 before it begins passing the response 52 to the user 50.

For efficiency, once the user 50 reaches the Peer Gateway 20, the Peer Gateway 20 and the user 50 may communicate directly. The communication need not be routed through the Peername System 11 and other layered or high level Peer Gateways 20 for each message transport between the Peer Gateway 20 and the user 50 (as might be done to route an initial UserRequest 51 to the Peer 30).

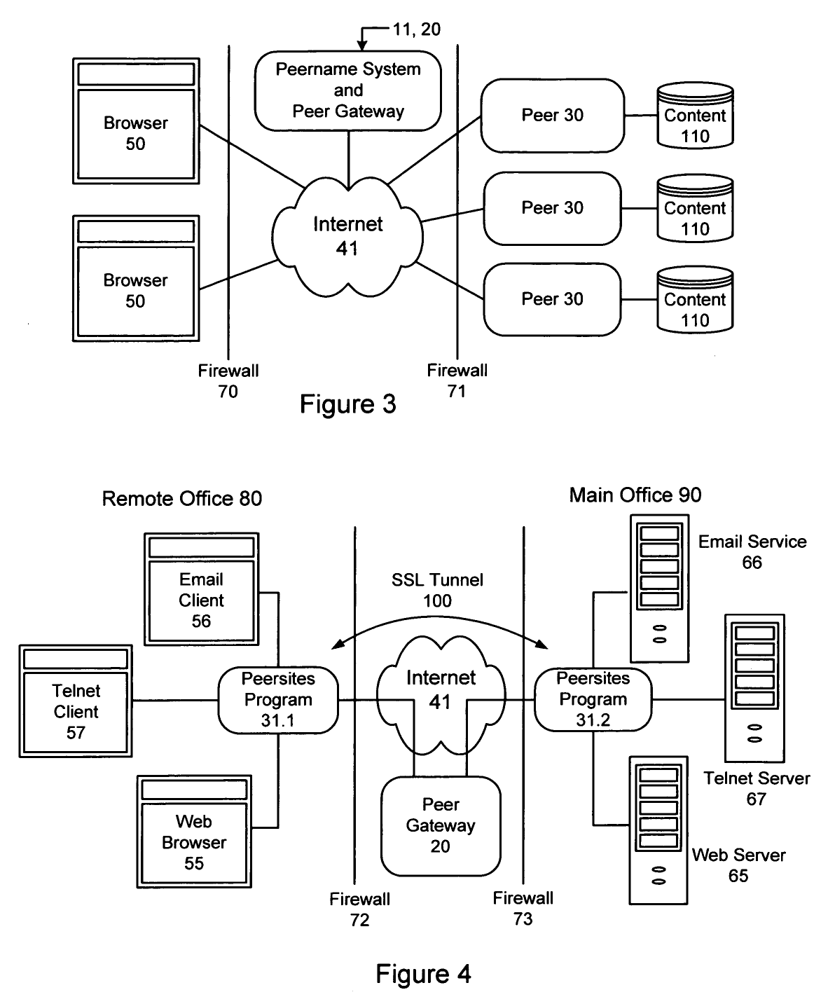

FIG. 3 shows that the Peername Service 11 and Peer Gateways 20 are designed to accommodate a multiplicity of users 50 and Peers 30 offering content 110. In the example shown, note that the computer network 40 over which the Peersites Network operates is the Internet 41. This diagram also depicts that the users 50 and the Peers 30 may respectively be located behind firewalls 70, 71 and the Peername Service 11 and Peer Gateways 20 are accessible via the Internet 41. According to the present invention, the communication between a browser 50 and a Peer 30 may include the step of putting a request from a browser 50 into a Peer Transport Protocol request, for example, the a transport protocol in which the peername of the intended Peer is included in the Protocol to enable the Gateway to effectively pass the request to the appropriate Peer.

The communication between users 50 and Peers 30 is designed to operate whether the user 50 or the Peer 30 is located behind a firewall. According to an embodiment of the present invention, a Peer 30 communicates with a Peer Gateway 20 without violating the firewall 72 security protocols. A user 50, likewise communicates with a Peer Gateway 20 without violating the user's firewall 71 security protocols. The Peer Gateway 20 provides the means of communication between the user 50 and the Peer 30, and the communication occurs through two firewalls 70, 71 without violation of the security protocols of either firewall.

It is noted that the users 50 may have browsers on various kinds of computer devices, including personal computers, personal digital assistants, mobile phones, laptop computers, and other devices configured for browsing computer networks, including for example, devices configured with micro-browsers for network or Internet access. According to the present invention, the Peersites Program 31 may be configured to run on various kinds of computer devices, including personal computers, personal digital assistants, mobile phones, laptop computers, and other devices that may communicate with computer networks and/or the Internet.

FIG. 4 shows an embodiment of the present invention configured for providing a tunnel for communication between two locations each of which contain a Peersites Program 31.1 and 31.2, respectively. The Peersites Program 31.1 is configured to communicate with a Web Browser 55, Email client 56, and Telnet client 57 located, for example, in a company's Remote Office 80 which is behind firewall 72. In the company's Main Office 90, which is located behind firewall 73, the Peersites Program 31.2 is configured to communicate with an Internal Web Server 65, Email Server 66, and Telnet Server 67. The Peersites Program 31.1 can initiate a communication with Peersites Program 31.2 by going through the Peername Service 11 and Peer Gateway 20. When Peersites Programs 31.1 and 31.2 communicate, they are able to set up a Network Tunnel 100 and thereby provide communications from the Web Browser 55 to the Internal web server 65, from the Email Client 56 to the Email Server 66, and from the Telnet client 57 to the Telnet server 67.

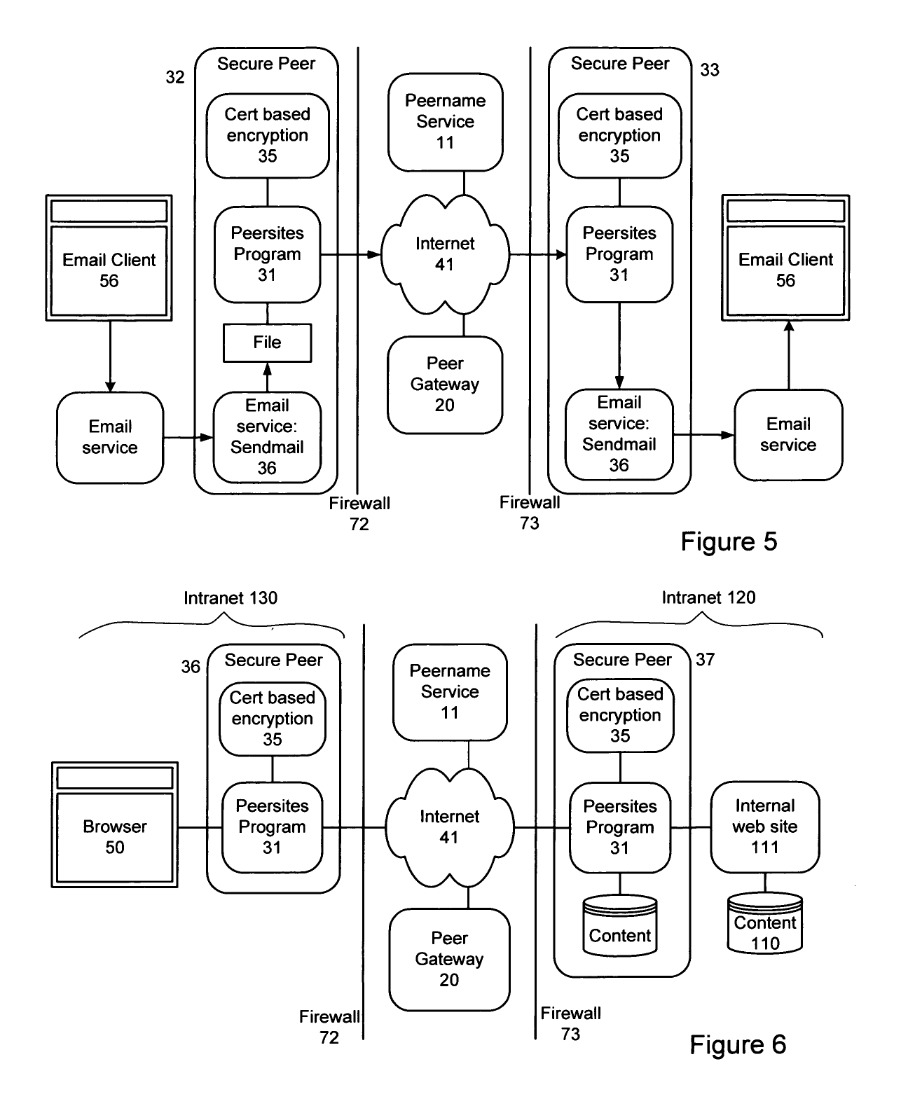

FIGS. 5 and 6 show a configuration similar to that depicted in FIG. 4 and showing the additional feature of employing Certificate based encryption for secure communications between the Peersites Programs 31. With the Certificate based encryption, such as the Public Key Infrastructure (PKI) technology as is known in the art, the Peersites Program 31 can set up a secure or SSL tunnel to another Peersites Program 31. In FIG. 5, the Secure Peer 32 has a security layer built on Certificate based encryption 35, and the Peersites Program 31 is configured to communicate with an Email service 36. When another Secure Peer 33 is similarly configured with Certificate based encryption 35, then the email services are transferred from Secure Peer 32 to Secure Peer 33 as encrypted bits, which will only be decrypted at the receiving Peer. The text or messages do not travel over the Internet 41 as unprotected clear text. As shown in FIG. 6, a similar arrangement may be set up for browsing an internal web site 111 behind a firewall 73 from, for example, another location which may be behind a firewall 72 such as remote office location or a home ISP connection to the Internet 41. A user 50 who runs a Secure Peer 36, may communicate via the Peername Service 11 and Peer Gateway 20 with a Secure Peer 37 in such a manner that content 110 available on an internal web site 111 is transported in an encrypted format from the Intranet 120 to Intranet 130.

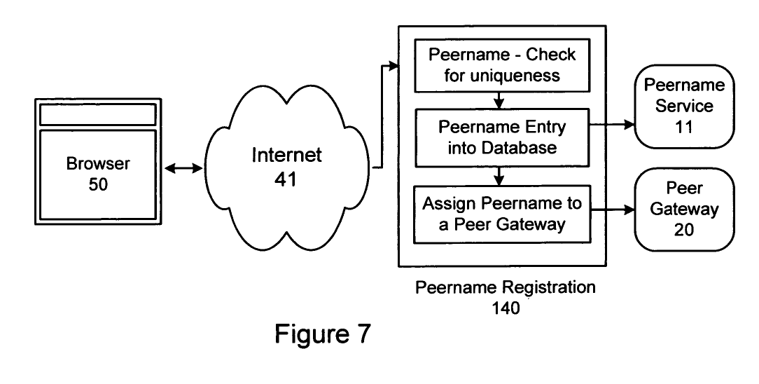

FIG. 7 shows the components of the Peername Registration System 140. The Peername Registration System 140 provides the means for an entity to register a Peername into the Peername Service 11. Peername Registration includes testing the Peername against existing Peernames in the system for uniqueness. Provided a Peername is unique, the Peername Registration System 140 will enter the new Peername into the database and enter the name into a Peername Server 10. The Peername Registration System 140 also associates the Peername with a Peer Gateway 20.

In order to make a Peer 30 accessible through the Peername Service 11 and Peer Gateway 20, one may download or otherwise acquire the Peersites Program 31 and load it onto an appropriate computer. The computer should have access to the computer network 40 upon which the Peername Service 11 and Peer Gateway 20 are operating. According to one embodiment of the invention, the computer network 40 is the Internet. The Peersites Program 31 should be configured with the Peername and login data in order for the Peersites Program 31 to log-in or authenticate itself to the appropriate Peer Gateway 20. According to one embodiment of the invention, the Peersites Program 31 is loaded with the specific Peer Gateway 20 through which the Peersites Program 31 is to be routed. According to a second embodiment of the invention, the Peersites Program 31 is configured to seek out the Peer Gateway 20 to which the Peer 30 is to be connected by going to the Peername Service 11. Thus, in much the same way as a user 50 would find the Peer Gateway 20 of a Peer 30, the Peersites Program 31 itself would go to the Peername Service 11 in order to find out which Peer Gateway 20 the Peersites Program 31 itself is supposed to log into. This second embodiment provides flexibility in how Peer Gateways 20 will be utilized and allows Peersites Network administrators to rearrange the structure and usage of all the Peer Gateway 20 servers.

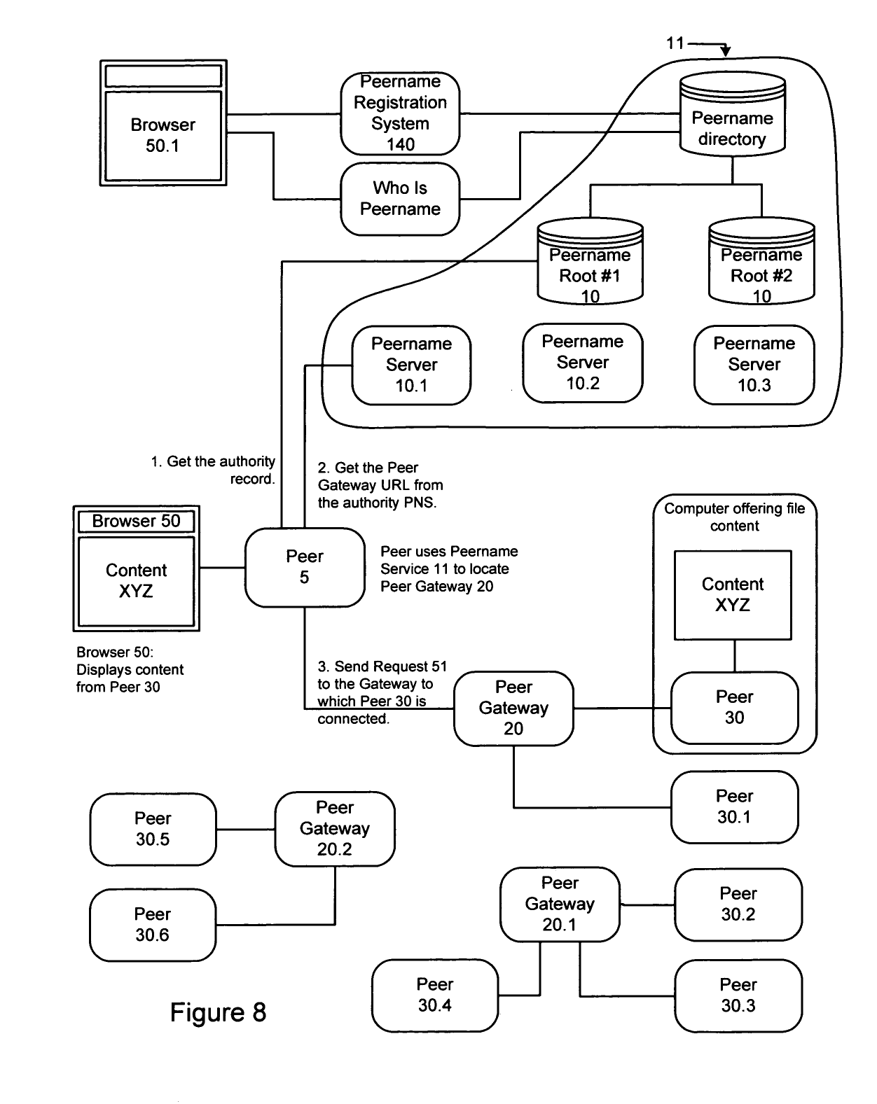

FIG. 8 shows a schematic of another embodiment of the Peersites Network. A browser 50.1 may be used to access the Peername Registration System 140 in order to register and perform maintenance functions for Peernames. The Peername Registration System 140 communicates with the Peername Service 11 to have registered Peernames entered into Peername Servers 10. A user uses a browser 50 to access a Peer 5. The Peer 5 can be running on the local machine (upon which the browser 50 is running), or may be on a Portal 12 (as shown in FIG. 2) on the Internet 41. The Peer 5 contacts the Peername Service 11, which uses a Peername Root server 10 to provide the Peername Server 10.1 (which is the authority record for the Peer domain of interest) to the Peer 5. Peer 5 then communicates with the Peername Server 10.1 to get the location of the Peer Gateway 20 associated with the Peername of interest. The Peer 5 is then connected to the Peer Gateway 20. Provided that Peer 30 is logged-in to (or has made the initial communication with) the Peer Gateway 20, the Peer Gateway 20 passes the request 51 from browser 50 to the Peer 30. In this way, a request 51 for Content XYZ from Peer 30 can be returned from Peer 30 via Gateway 20 to Peer 5 which passes Content XYZ to display in browser 50. As further shown in FIG. 8, there are numerous other Peer Gateways 20.1, 20.2 to which other Peers 30.1-30.6 are connected. A user may seek any Peer 30 according to its Peername, and will be routed to the Peer 30 through the appropriate Peer Gateway 20.

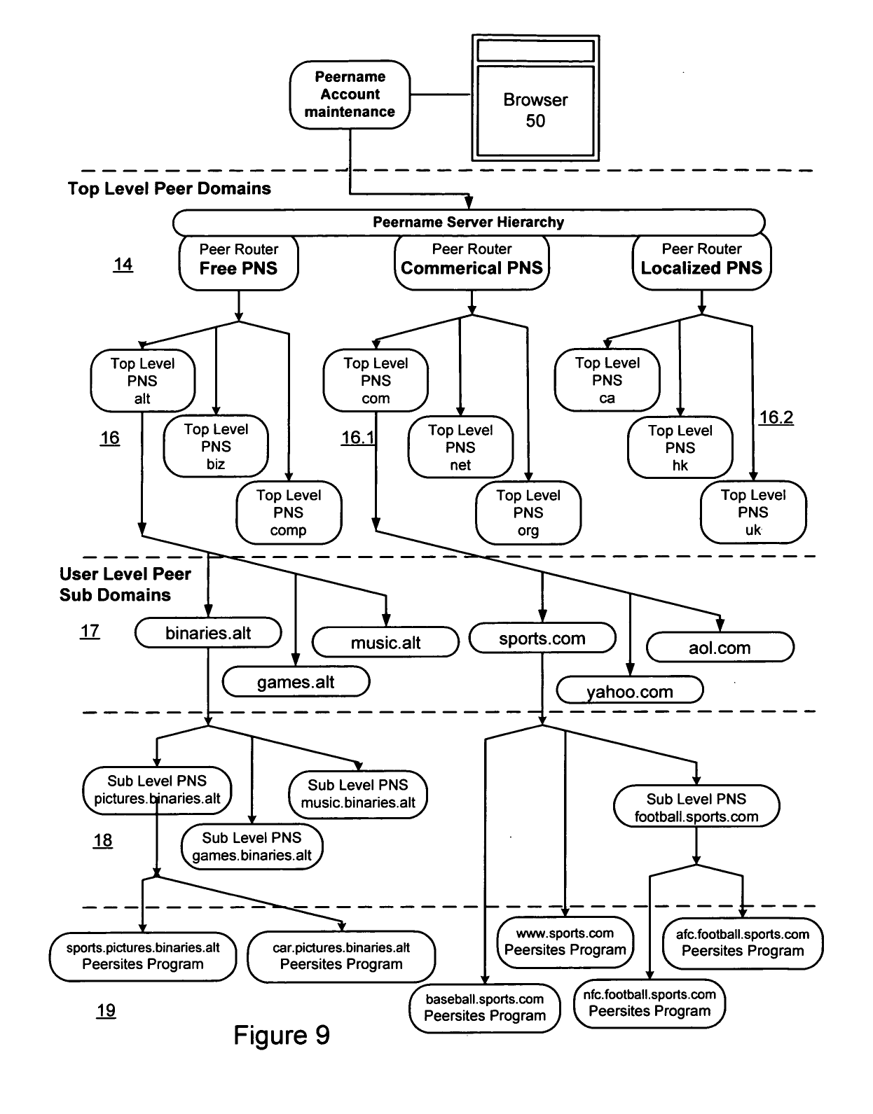

FIG. 9 shows one embodiment of the Peername Service 11 depicting an exemplary system hierarchy. According to the example shown, there may be various high level Peer Routers 14 that accordingly have sublevels of naming hierarchy under them. For example, there may be some free Peername Service domains 16 such as .alt, .biz, or comp, as well as commercial Peername Service domains 16.1 such as .com, .net, and org, and yet other Peername Service domains 16.2 for localized areas, such as .ca, .hk, and uk. According to the Peername Service 11, a Peername Server 10 for each of the various Peername Service domains 16, subdomains, 17 and layers of sub domains 18, 19 thereunder may be set up in the hierarchical fashion shown. In determining the location of a Peer 30 that has a certain Peername, the Peername Service 11 routes through the various Peername Servers 10 from the top level down through the sublevels until it reaches the desired Peername Server 10, which provides the Peer Gateway 20 to which the Peer 30 is associated.

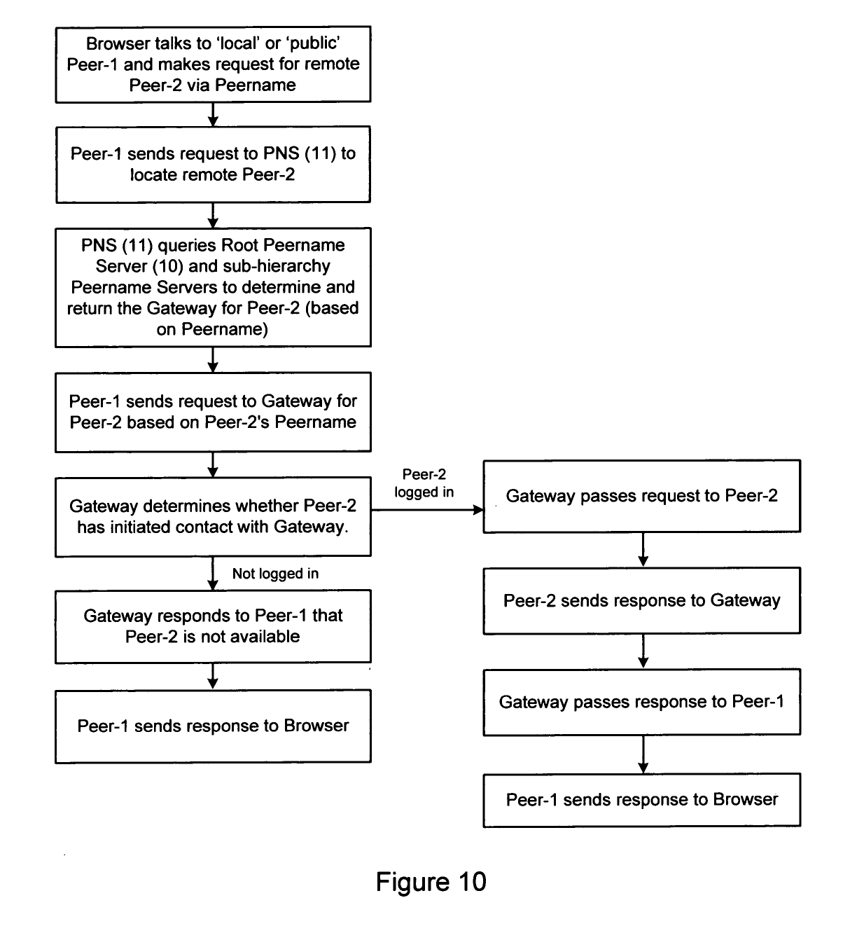

As shown in FIG. 10, a browser 50 can communicate with a Peer-1, whether that Peer-1 is on the local computer (i.e. the computer upon which the browser 50 is running), or whether that Peer-1 is on, for example, a Portal 12 (as shown in FIG. 2) such as a computer running on a web site on the Internet. In the latter case, the Peer-1 may be referred to as a Public Peer. Using the concept of the Public Peer can be beneficial by allowing a user to access Peers on the Peersites Network without needing any software on the user's computer other than the common web browser. The Public Peer can be maintained as a separate operational component, or can be integrated into components such as the Peername Service 11 and Peer Gateway 20.

The Peer-1 makes a request to the Peername Service 11 to locate a Peer-2 via Peer-2's Peername. According one embodiment of the present invention, the Peername Service 11 queries the Peername Servers 10 (including Root Peername Servers and lower Peername Servers in the hierarchical system) in order to determine the location of the Peer Gateway 20 associated with Peer-2. Then the Peername Service 11 responds to Peer-1 with the Peer Gateway 20 location. In this scenario, the Peer-1 makes one call to the Peername Service 11, and the Peername Service 11 (after making internal determinations) sends one response to Peer-1 to provide the Peer Gateway 20 location. According to another embodiment of the invention, the Peername Service 11 responds to the Peer-1 with a location for the Root Peername Server 10. Peer-1 then queries Root Peername Server 10 to get the location or Internet address of Root Peername Server 10.1 (for ‘.alt’ Peernames, for example). Peer-1 then queries alt Root Peername Server 10.1 for the Peername Server for the alt Peername of interest. There may be numerous Peername Server levels in coming to the Peername Server 10.x that holds the Peer Gateway location for any given Peername. In this scenario, Peer-1 makes multiple calls to multiple Peername Servers in order to ultimately retrieve the location of Peer Gateway 20 with which the target Peer-2 is associated. This can be an advantageous procedure since Peername Servers may be distributed to various locations on a network or various IP addresses on the Internet. With such a system, for example, the load is removed from the Peername Service 11 and placed on the Peer-1 to make various requests to find the Peer Gateway 20.

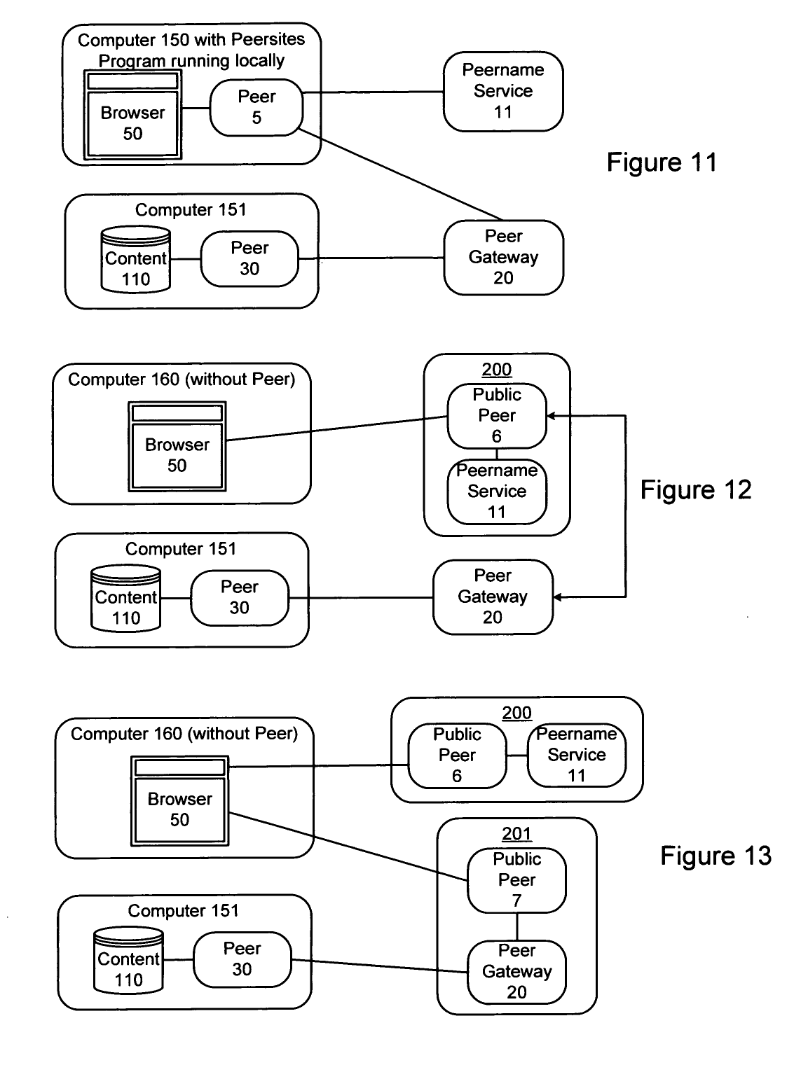

As shown in FIGS. 11-13, there are various configurations of the service by which communication from a user with a browser 50 receives content from a Peer 30. In FIG. 11, the user's computer 150 has a browser 50 and Peer 5 running locally. That is, the computer 150 is running a Peersites Program 31 (as shown for example in FIG. 1). The Peer 5 communicates with the Peername Server (PNS) 11 to get the location of Gateway 20. Then the Peer 5 communicates with Gateway 20, which passes communications to Peer 30. Computer 151 runs Peer 30 so that a user on computer 150 can locate computer 151 by a peername associated with Peer 30. Peer 30 can run the various applications as discussed above, such as serving content, offering desktop access via VNC, running web applications of numerous varieties, or running, for example, a Wiki, or web log application. These applications are exemplary only, and other applications known in the art should be accessible over the Peersites network.

FIG. 12 shows a configuration in which the computer 160 has a browser 50, but does not have a Peersites Program 31 running locally. Such a computer 160 can still access a computer 151 over the Peersites Network (via the peername associated with Peer 30 on computer 151) by accessing a Public Peer 6. In this exemplary configuration, the Public Peer 6 is running at the same network location 200 as the Peername Service 11. The network location 200 could represent, for example, that the Public Peer 6 and the Peername Service 11 are running on the same computer, or are on different computers, but on the same local area network. Another alternative (not shown in FIG. 12) is that the Public Peer 6 could run on some other Portal 12 accessible on the computer network 40 (as described in FIG. 1). The browser 50 communicates with the Public Peer 6, which communicates with the Peername Service 11. The Peername Service 11 provides the location of the Gateway 20 to which the Peer 30 is associated. The Public Peer 6 then communicates with the Gateway 20, which communicates with the Peer 30. In this way, the path from computer 160 (browser 50) to computer 151 (Peer 30) goes through the Public Peer 6 to Gateway 20. Gateway 20 need not be on the same network location 200 with the Public Peer 6 (that is, Public Peer 6 and Gateway 20 may be in different physical locations).

FIG. 13 shows a configuration in which the computer 160 has a browser 50, but does not have a Peersites Program 31 running locally. Similar to the configuration in FIG. 12, the browser 50 communicates with Public Peer 6, which communicates with the Peername Service 11 to attain the location of Peer Gateway 20. Public Peer 6 and Peername Service 11 may again share the same network location 200 (i.e. same computer or on the same local area network). Once Public Peer 6 returns the location of Peer Gateway 20 (the Peer Gateway associated with the peername for computer 151) to browser 50, then browser 50 makes a connection to a Public Peer 7 that is running on the same computer 201 as the Gateway 20 (alternatively, 201 could represent a local area network, such that Public Peer 7 and Gateway 20 are in the same physical location, but running on different CPUs). By having browser 50 connect with Public Peer 7, the path from computer 160 to computer 151 makes a link through a single network location 201, rather than through a network location 200 and 201 as shown in FIG. 12. In accordance with the various embodiments herein, a mode of practice of the invention includes a communication link between Gateway 20 and Peer 30 in which Peer 30 creates two HTTP links with Gateway 20. The first is a request with an essentially infinite body length, and the second is a response with an infinite body length. This communicates a logged-in or ready state of Peer 30 to Gateway 20, and allows Gateway 20 to send and receive TCP/IP packets on the already existing communication links.

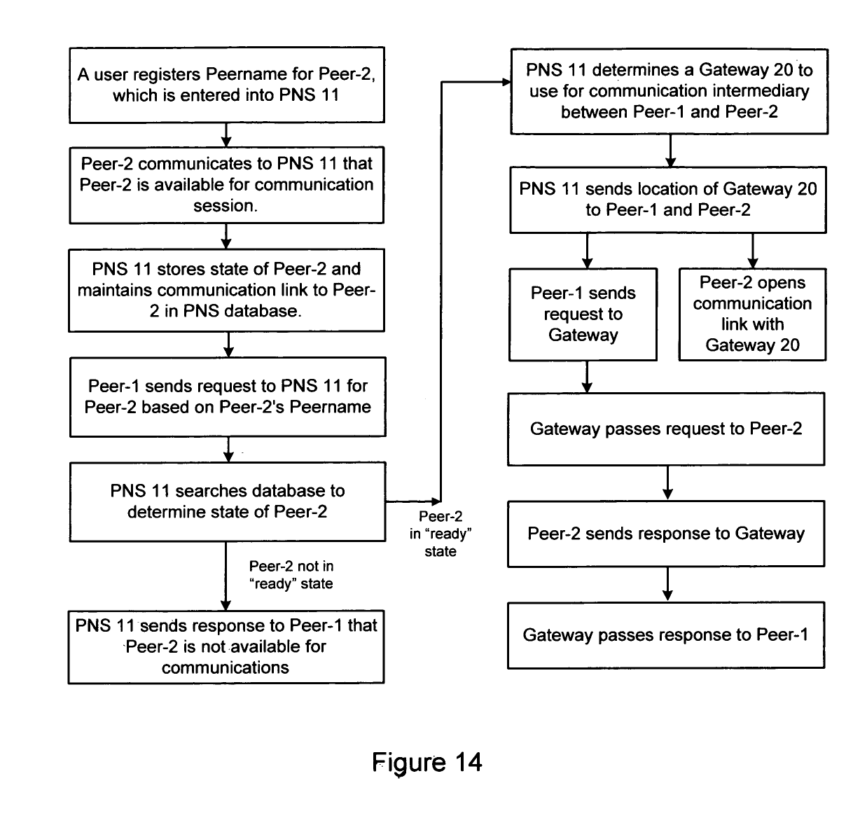

As shown in the flow chart of FIG. 14, an alternative embodiment of the present invention provides that the Peername Service (PNS) 11 maintains connection and communication information for the Peersites Network that can be used to actively and dynamically control the loads of the Peer Gateways 20. A user registers a Peername for Peer-2. The Peername Service 11 stores the Peername for Peer-2 in the Peername Service 11 database. Anytime the user wants to make Peer-2 available on the Peersites Network, the user starts Peer-2, which communicates to the Peername Server 11 that Peer-2 is available for communications. The Peername Service 11 stores the state of Peer-2 as ‘ready’ and maintains the communication link with Peer-2.

Peer-1 requests of the Peername Service 11 to communicate with Peer-2. The Peername Service 11 will then check the status of Peer-2. If Peer-2 is connected and in a “ready” state, then the Peername Service 11 will determine an appropriate Peer Gateway 20 through which to route the communication between Peer-1 and Peer-2. The Peername Service 11 may use a load balancing algorithm, and take into account the physical location of Peer-1 and Peer-2, as well as any other factors deemed relevant, in order to determine what Peer Gateway to use. The Peername Service 11 then sends the address of the Peer Gateway 20 to both Peer-1 and Peer-2. Peer-1 then sends the request (intended for Peer-2) to Gateway 20. Peer-2 opens a communication with Gateway 20. This enables the Gateway 20 to pass the request from Peer-1 to Peer-2. Peer-2 sends a response back to Gateway 20, which Gateway 20 passes to Peer-1.

In accordance with FIG. 14, after a communication request for Peer-2 is received by the Peername Service 11, the communication link between a Gateway 20 and Peer-2 is established. This communication link could be maintained indefinitely (to satisfy subsequent requests for Peer-2), or could be terminated upon some pre-defined metric (such as a period of inactivity of requests for Peer-2), in which case Peer-2 would be re-connected to the Peername Service 11 and placed in a ready state. This would free the connection load on the Gateway 20.

The above-described arrangements are merely illustrative of the application of the principles of the present invention. Other arrangements may be devised by those skilled in the art without departing from the spirit or scope of the inventions. Although the arrangements are described in the context of a computer network, it will be apparent that they are equally applicable to other types of data communications systems, such as, but not limited to, telecommunications networks, data communications networks, or other types of computer networks that may not use the Internet or DNS servers to make network connections as was described in certain embodiments of the present invention.

1. A method of using a computer network comprising the steps of:
(a) Registering a multiplicity of Peernames, each Peername associated with at least one Peersites Program;
(b) Maintaining a database of the multiplicity of Peernames on a server connected to the computer network;
(c) Maintaining an association between each of the multiplicity of Peernames and at least one Peer Gateway, where the Peer Gateway is on the computer network;
(d) Accepting a UserRequest from a user on the computer network, such UserRequest directed to a specific Peername;
(e) Determining the Peer Gateway associated with the specific Peername;
(f) Determining whether a Peersites Program associated with the specific Peername has logged-into the Peer Gateway, and if so, forwarding the UserRequest to the Peersites Program;
(g) Accepting a response from the Peersites Program;
(h) Forwarding the response to the user.

2. The method of claim 1, wherein the computer network is the Internet.

3. The method of claim 1, wherein the computer network is a local area network.

4. The method of claim 1, wherein the Peersites Program is located on a personal computer that has a connection to the Internet.

5. The method of claim 1, wherein at least one of the Peernames is associated with one and only one Peersites Program.

6. The method of claim 1, wherein the UserRequest is transformed into a Peer Transport Protocol compliant request and such Peer Transport Protocol compliant request is forwarded to the Peersites Program.

7. The method of claim 1, wherein the Peersites Program executes a routine to communicate over the computer network with the Gateway server.

8. A method of using a computer network comprising the steps of:
(a) Storing a multiplicity of Peernames on a first server accessible by computers on the computer network;
(b) Associating a second server with at least one of the Peernames;
(c) allowing a first computer to communicate with the first server and identify itself as the at least one of the Peernames to the first server;
(d) having the first server provide the location of a second server to the first computer;
(e) allowing the first computer to communicate with and identify itself as the at least one of the Peernames to the second server;
(f) allowing a second computer to communicate with the first server and seek the at least one of the Peernames;
(g) having the first server provide the location of the second server to the second computer;
(h) allowing the second computer to communicate with the second server and to request an action associated with the Peername;
(i) having the second server pass-through the requested action to the first computer;
(j) having the first computer serve a result of the action to the second server;
(k) having the second server provide the result to the second computer.

9. A method of using a computer network comprising the steps of:
(a) Storing a multiplicity of Peernames on a first server accessible by computers on the computer network, each of the Peernames associated with a second server;
(b) allowing a first computer to run a Peersites Program, by which the first computer can communicate with and identify itself as one of the multiplicity of Peernames to the second server;
(c) allowing a second computer to communicate with the first server and seek the one of the multiplicity of Peernames from the first server;
(d) having the first server provide the location of the second server to the second computer;
(e) allowing the second computer to communicate with the second server and make a request designated to the Peername;
(f) having the second server pass the request to the first computer;
(g) having the first computer serve a response to the request to the second server;
(h) having the second server provide the response to the second computer.

10. The method of claim 9, wherein the second computer does not require software other than commercially available operating system and Internet browser software.

11. The method of claim 9, wherein the location of the first server is provided as an IP Address.

12. The method of claim 9, wherein the location of the first server is designated by a URL or URI that can be resolved through the Domain Name System (DNS) on the Internet to thereby locate the first server on the Internet.

13. The method of claim 9, wherein the location of the second server is provided as an IP Address.

14. The method of claim 9, wherein the location of the second server is designated by a URL or URI that can be resolved through the Domain Name System (DNS) on the Internet to thereby locate the second server on the Internet.

15. The method of claim 9, wherein the Peername is independent of the IP address of the computer on which the Peersites Program is running.

16. The method of claim 9, wherein the computer network is the Internet

17. A computer system comprising:
(a) a first computer running a Peername Service program, the Peername Service program having at least one name, the at least one name representing an auxiliary computer;
(b) at least one gateway program, the Peername Service program associating the at least one name with the at least one gateway program, wherein a user using a third computer may access the Peername Service program to retrieve the location of the at least one gateway program, and wherein the auxiliary computer communicates with the at least one gateway program,
(c) and the user may communicate with the gateway program to thereby create a communication link from the user to the auxiliary computer.

18. The computer system of claim 17, wherein the at least one gateway is on a second computer.

19. The computer network of claim 17, wherein the first computer is accessible on the Internet.

20. The computer network of claim 18, wherein the second computer is accessible on the Internet.

21. A method of locating a computer on a computer network comprising the steps of:
(a) registering a name for the computer on a name server;
(b) associating the name with a routing server;
(c) accepting a login connection from the computer to the routing server;
(d) accepting a request from a user for the computer where the request is the name of the computer;
(e) directing the user to the routing server;
(f) connecting the user to the computer through the routing server.

22. The method of claim 21, wherein the login connection from the computer may be made where the computer is behind a firewall.

23. The method of claim 21 wherein the user the request from the user may be made where the user is behind a firewall.

24. A method of setting up a communication tunnel between a first computer and a second computer, where the first computer and second computer are in private intranets, each behind a firewall, and where each of the first and second computers have access to the Internet, but do not have a URL on the Internet, comprising the steps of:
(a) running Peersites Programs on the first and on the second computer;
(b) registering a name of the first computer;
(c) allowing the first computer to access a gateway server;
(d) on a name server, accepting a request for the name of the first computer from the second computer;
(e) routing the second computer to the gateway server associated with the name of the first computer;
(f) establishing a communication tunnel through the gateway server from the first computer to the second computer via the Peersites Program functionality.
